(19) United States
(12) Patent Application Publication
(10) Pub. No.: US 2008/0121169 A1
(43) Pub. Date: May 29, 2008

(54) Usage Indicator for a Cartridge

(76) Inventor: Samuel Tsui, Hong Kong (CN)

Correspondence Address: BERENATO, WHITE & STAVISH, LLC, 6550 ROCK SPRING DRIVE, SUITE 240, BETHESDA, MD, 20817, US

(21) Appl. No.: 11/795,983

(22) PCT Filed: Jan. 25, 2006
(86) PCT No.: PCT/AU06/00076

§ 371 Date: Jul. 25, 2007

(30) Foreign Application Priority Data
Jan. 25, 2005 (AU) 2005900283

(51) Int. Cl. G01D 21/00

(52) U.S. Cl. 116/208

(57) ABSTRACT

A usage indicator 12 for a process cartridge 10 comprising a reflective tab 18; a shutter 26 connected to a rotatable mounting platform 20; and engaging means 38 attached to the rotatable mounting platform 20. In its initial state, the shutter 26 covers the reflective tab 18 in such a manner as to prevent the reflective tab 18 from reflecting light emitted by an external light sensing system. At the same time, the engaging means 38 engages a gear in a gear train 14 of the process cartridge 10. During first operation of the gear train 14 the gear train 14 engages the engaging means 38 to rotate the rotatable mounting platform 20 and thereby uncover at least a portion of the reflective tab 18 able to reflect light emitted by the external light sensing system. The rotation of the mounting platform 20 continues until the engaging means 38 no longer engages the gear train 14.

### FIELD OF THE INVENTION

The invention relates to a usage indication means for a cartridge. In particular, the invention relates to a mechanism that allows an image forming apparatus to determine whether the cartridge is brand new during the ordinary operation of the cartridge.

### BACKGROUND TO THE INVENTION

The following discussion of the background of the invention is intended to facilitate an understanding of the present invention. However, it should be appreciated that the discussion is not an acknowledgment or admission that any of the material referred to was published, known or part of the common general knowledge in any jurisdiction as at the priority date of the application.

Image processing apparatus often use light sensing systems to detect the presence of a process cartridge and its status. These light sensing systems typically incorporate a light emitting device and a light sensing device. The light emitting device relies on a reflective element in the process cartridge to reflect light back to the light sensing device and thereby indicate the correct insertion of the process cartridge. In some systems, the angle by which light is reflected back to the light sensing device by the reflective element may also indicate the toner level of the process cartridge.

The problem with these systems is that the reflective element must be accurately positioned to allow the system to properly function. This requirement for accuracy creates difficulties in remanufacturing or reconditioning the process cartridge.

It is therefore an object of the present invention to provide a usage indicator means for a process cartridge that overcomes, or at least reduces the effects of, one or more of the above mentioned problems.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”

In accordance with a first aspect of the invention there is a usage indicator for a cartridge comprising:
a reflective tab;
a shutter connected to a rotatable mounting platform; and
engaging means attached to the rotatable mounting platform,
   where, in its initial state, the shutter covers the reflective tab in such a manner as to prevent the reflective tab from reflecting light emitted by an external light sensing system and the engaging means engages a gear in a gear train of the cartridge and where during first operation of the gear train the gear train engages the engaging means to rotate the rotatable mounting platform and thereby uncover at least a portion of the reflective tab able to reflect light emitted by the external light sensing system, the rotation of the mounting platform to continue until the engaging means no longer engages the gear train.

Ideally, the usage indicator further includes spring means adapted to draw an engaging recess integrally formed with the rotatable mounting platform towards a mounting pin positioned proximate the rotatable mounting platform when the engaging means no longer engages the gear train. The spring means may take the form of a spring clip retained on a shaft to which the rotatable mounting platform is also mounted.

Preferably, the engaging means are teeth integrally formed with the rotatable mounting platform.

The shutter may be connected to the rotatable mounting platform by way of a support arm.

The rotatable mounting platform may be mounted on a shaft. This mounting may be facilitated by a sliding slot, provided in the rotatable mounting platform. In one configuration where the engaging means are teeth, preferably the sliding slot has a length greater than the height of the teeth.

In yet another alternative configuration, the shaft moves further away from the reflective tab as the toner contained in the process cartridge is depleted.

In accordance with a second aspect of the present invention there is a cartridge incorporating a usage indicator according to the first aspect of the invention.

### BRIEF DESCRIPTION OF THE DRAWINGS

The invention will now be described, by way of example only, with reference to the accompanying drawings, in which;

FIG. 1 is an isometric view of a process cartridge with a first area cut away to expose a usage indicator means of the present invention.

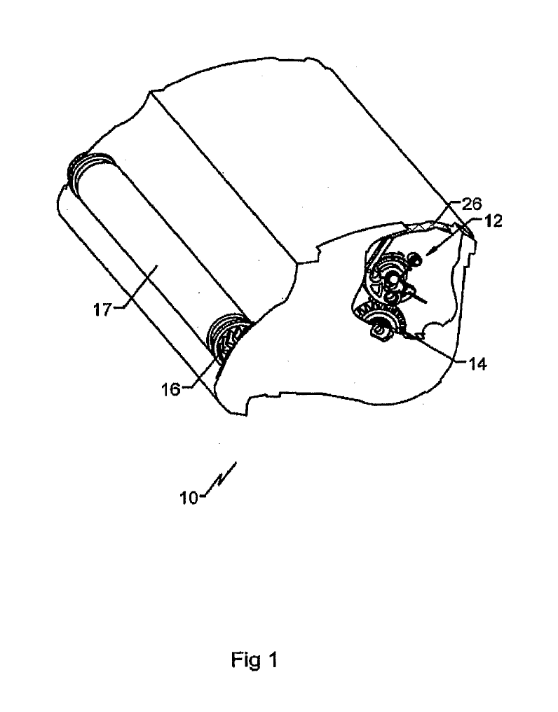

FIG. 2 is a plan cross-sectional view of the process cartridge shown in FIG. 1.

FIG. 3 is a plan cross-sectional view of the exposed area of the process cartridge shown in FIG. 1.

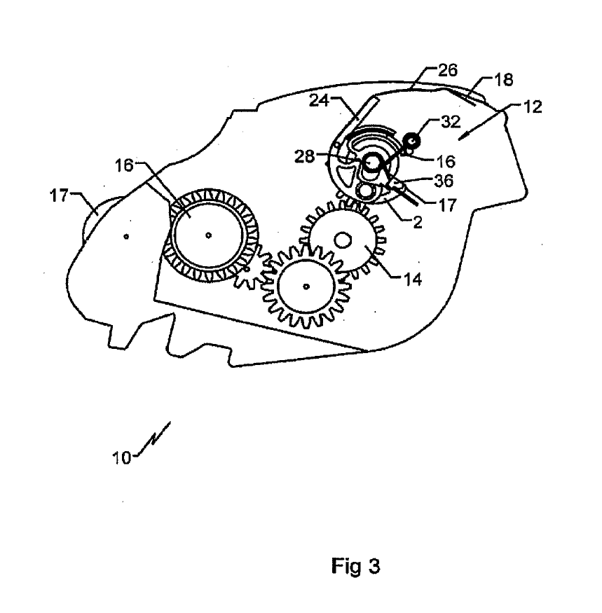

FIGS. 4a to 4c are plan cross-sectional views of the usage indicator means of the present invention in various states of operation.

### PREFERRED EMBODIMENTS OF THE INVENTION

In accordance with the preferred embodiment of the invention there is a process cartridge 10 incorporating a usage indicator means 12.

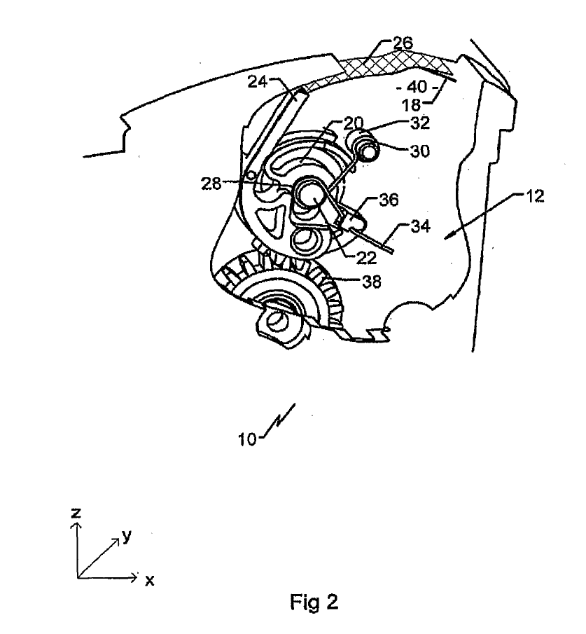

The process cartridge 10 includes a gear train 14 as shown in FIG. 2. The gear train 14 includes a primary gear 16. The primary gear 16 forms part of the developer roller assembly 17. Rotational movement applied to the primary gear 16 is transferred to the usage indicator means 12 by way of the gear train 14. This will be explained in more detail below.

The process cartridge 10 also includes a reflective tab 18. The relative position of the reflective tab 18 will also be explained in more detail below.

The usage indicator means 12 takes the form of a circular mounting platform 20. The circular mounting platform 20 is able to freely rotate about shaft 22. Shaft 22 connects the circular mounting platform 20 to the main body of the process cartridge 10.

Protruding from the circular mounting platform 20 is a support arm 24. The support arm 24 is positioned such that when the circular mounting platform 20 rotates about shaft 22, the support arm 24 rotates in the same xz plane. In the embodiment shown, the support arm 24 is integrally formed with the circular mounting platform 20.

Attached to the support arm 24 at the end not integrally formed with the circular mounting platform 20 is a shutter 26.

Encircling the shaft 22 is a spring clip 28. One end 30 of the spring clip 28 encircles a mounting pin 32. The other end 34 of the spring clip 28 abuts an engaging recess 36. The spring clip 28 is biased such that the ends 30, 34 meet in its non-tensioned state.

The engaging recess 36 is also integrally formed with the circular mounting platform 20,

Spaced about the circumference of the circular mounting platform 20, at a position approximately one quarter turn anti-clockwise from the support arm 24, is a plurality of engaging teeth 38. The engaging teeth 38 are of a size and shape as to engage the teeth of the final gear in the gear train 14.

The invention will now be described in the context of its use.

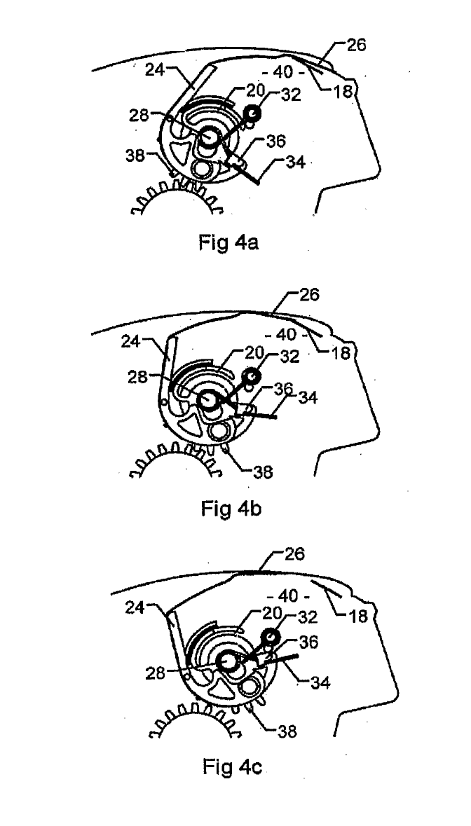

As shown in FIG. 4a, a brand new process cartridge is configured such that the shutter 26 overlies the reflective tab 18 at an opening 40. The two engaging teeth 38 furthest from the support arm 24 engage the teeth of the final gear in the gear train 14. This spaces the respective ends 30, 34 of the spring clip 28 to their widest operable positions.

While the spring clip 20 is biased such that the ends 30, 34 meet in its non-tensioned state, the compressive force of the bias is insufficient to overcome the resistive force of the gear train 14. As such, the engaging teeth 38 remain interlocked with the teeth of the final gear in the gear train 14 until other operational forces intervene.

In this state, because the shutter 26 overlies the reflective tab 18, the light sensing systems of the image forming apparatus (not shown) to which the process cartridge 10 is to be inserted are able to ascertain that the process cartridge has not been used before.

This changes on the process cartridge 10 being properly installed in to the image forming apparatus and subsequently instructed to print an image.

Upon receipt of the instructions to print an image, the image forming apparatus transfers a rotational driving force to the developer roller assembly 17. This in turn transfers the rotational driving force to the primary gear 16. The rotational driving force applied to the primary gear 16, through the interrelationships of the gear train 14, cause the final gear in the gear train 14 to rotate in a clockwise direction.

The interlocking relationship between the teeth of the final gear and the engaging teeth 38 results in the clockwise rotation of the final gear causing a corresponding anti-clockwise rotation in the circular mounting platform 20. This anti-clockwise rotation of the circular mounting platform 20 is assisted by the bias in the spring clip 28.

When all of the engaging teeth 38 are no longer interlocked with the teeth of the final gear, the bias in the spring clip 28 takes over. As this bias takes over, the bias retains end 34 in engaging recess 36. However, as the bias is stronger than the resistive force provided by the engaging recess 36, the bias applied to the engaging recess 36 by way of end 34 rotates the circular mounting platform 20 until the engaging recess abuts the mounting pin 32. The bias applied to the end 34 then retains the circular mounting platform 20 in this position, thereby keeping the usage indicator means 12 from interfering with the subsequent operation of the process cartridge 10.

As the circular mounting platform 20 rotates in an anti-clockwise direction, the free end of the support arm 24 is drawn further towards the centre of the process cartridge 10. This also causes the shutter 26 to be drawn away from the reflective tab 18. With the shutter 26 no longer overlying the reflective tab 18, the light sensing systems of the image forming apparatus (not shown) to which the process cartridge 10 is to be inserted are able to ascertain that the process cartridge 10 has been used.

Once used, it becomes apparent that it is not possible to restore the cartridge to its initial “unused” status by way of the usage indicator means 12 without disassembling the cartridge.

It should be appreciated by the person skilled in the art that the invention is not limited to the embodiment described. In particular, the following modifications and improvements may be made without departing from the scope of the present invention:
The support arm 24 may be omitted and, in its place, the shutter 26 may be mounted directly to the circular mounting platform 20.
The number of engaging teeth 38 may vary, so long as the engaging teeth 38 remain free of engagement with the final gear following initial activation of the process cartridge.
Engaging teeth 38 may be replaced by some other engagement mechanism. The constraints of such mechanism are that it must remain free of engagement with the final gear following initial activation of the process cartridge. For example, in one alternative, the engagement mechanism may take the form of a plurality of retractable pins that engage with the final gear during initial operation and thereafter retract back into the circular mounting platform 20.
The spring clip 28 may be omitted. Alternatively, the spring clip 28 may be replaced with other mechanisms that apply a force that disengages the engaging teeth 38 from the final gear following initial activation of the process cartridge.
The circular mounting platform 20 may include a sliding slot into which the shaft 22 is received. Ideally, the sliding slot is of a length greater than the height of the engaging teeth 38. In this manner, during remanufacture of the process cartridge, the usage indicator means 12 may be reset by pushing the circular mounting platform 20 along the sliding slot away from the final gear and rotating the circular mounting platform 20 in a clockwise direction until it reaches its initial “unused” position.
The usage indicator means 12 may be able to move in the z plane following initial operation in line with the current toner level of the cartridge. In this manner, as toner level is depleted, the shaft 22 moves closer to the final gear.

This movement also causes the shutter 26 to move further in an anti-clockwise direction. Adopting this configuration in combination with a reflective tab 18 larger than that shown in the Figures, it is possible to set up a system whereby the shutter 26 may still cover a portion of the reflective tab 18 following initial operation. This covered portion is reduced as the toner level reduces according to the preceding description. As each covered portion becomes uncovered, the newly exposed portion can reflect back light emitted by the light sensing systems of the image forming apparatus and thus indicate the approximate toner level of the process cartridge.
While the invention has been described in the context of a process cartridge, the invention may be applied to other cartridge types, such as a developer cartridge.

It should be further appreciated by the person skilled in the art that the features described in one embodiment, where not mutually exclusive or alternatives, may be combined with features described in other embodiments to create yet further embodiments that fall within the scope of the present invention.

1. A usage indicator for a cartridge comprising:
a reflective tab;
a shutter connected to a rotatable mounting platform; and
engaging means attached to the rotatable mounting platform, where, in its initial state, the shutter covers the reflective tab in such a manner as to prevent the reflective tab from reflecting light emitted by an external light sensing system and the engaging means engages a gear in a gear train of the cartridge and where during first operation of the gear train the gear train engages the engaging means to rotate the rotatable mounting platform and thereby uncover at least a portion of the reflective tab able to reflect light emitted by the external light sensing system, the rotation of the mounting platform to continue until the engaging means no longer engages the gear train.

2. A usage indicator for a cartridge according to claim 1, further including spring means adapted to draw an engaging recess integrally formed with the rotatable mounting platform towards a mounting pin positioned proximate the rotatable mounting platform when the engaging means no longer engages the gear train.

3. A usage indicator for a cartridge according to claim 2, where the spring means is a spring clip retained on a shaft to which the rotatable mounting platform is also mounted.

4. A usage indicator for a cartridge according to claim 1, where the engaging means are teeth integrally formed with the rotatable mounting platform.

5. A usage indicator for a cartridge according to claim 1, where the shutter is connected to the rotatable mounting platform by way of a support arm.

6. A usage indicator for a cartridge according to claim 1, where a shaft is received within a sliding slot provided in the rotatable mounting platform.

7. A usage indicator for a cartridge according to claim 6, where the engaging means are teeth integrally formed with the rotatable mounting platform, and where the sliding slot has a length greater, than the height of the teeth.

8. A usage indicator for a cartridge according to claim 1, where the shaft moves further away from the reflective tab as the toner contained in the process cartridge is depleted.

9. A cartridge including a usage indicator according to claim 1.

10-11. (canceled)
